(19) United States
(12) Patent Application Publication
(10) Pub. No.: US 2008/0005556 A1
(43) Pub. Date: Jan. 3, 2008

(54) Method of Securing Operations Over a Network and Associated

(76) Inventors: Cyril Lalo, Paris (FR); Philippe Guillaud, Paris (FR)

Correspondence Address: RATNERPRESTIA, P O BOX 980, VALLEY FORGE, PA, 19482-0980, US

(21) Appl. No.: 11/578,021

(22) PCT Filed: Apr. 15, 2005
(86) PCT No.: PCT/FR05/00924

§ 371 Date: Oct. 10, 2006

(30) Foreign Application Priority Data
Apr. 16, 2004 (FR) 0404077

(51) Int. Cl. H04L 9/32

(52) U.S. Cl. 713/156; 713/155

(57) ABSTRACT

The invention relates to a method of securing operations carried out in a network between a user (1) and a service provider (2) and to the associated devices. For the user (1), the inventive method comprises the following steps, namely: a step (33) in which a dynamic encryption key is generated, a step (33) in which an authentication datum (15) received from the service provider (2) is encrypted with the aid of the dynamic encryption key, and step (35) in which the encrypted authentication datum (4) is sent to the service provider (2). For the service provider (2), the method comprises the following steps, namely: a step comprising the dynamic decryption (5) of the encrypted authentication datum (4) and a step comprising the verification (5) of the decrypted authentication datum, in order to authorise the operation in secure mode (13).

The present invention pertains to a method and devices for the securing of transactions or of interactions, hereinafter called operations, over a network between a user and a service or product provider, hereinafter called service provider.

The Internet network offers electronic operations of increasingly expanding prospects. It is found, however, that the lack of reliability of electronic operations is harmful to the development of this potential. Fraud and pirating act as a brake on the expansion of these operations.

To secure operations over a network from an Internet site of a service provider, for example, a currently known solution consists of the issuing of a certificate by a certification authority, which has tested the reality of the service provider. In general, an icon, such as a padlock, then appears on the site of the service provider, which is viewed from a device made available to a user.

An example of such a solution is the SSL (Secured Socket Layer) protocol for the securing of operations between user and service provider site. An operation in SSL secure mode functions if the site of the service provider is certified and the encryption is thus guaranteed.

However, this solution does not make it possible to solve all fraud situations because accommodating certificates can be obtained.

Thus, some fraud techniques, such as the one known by the name of “Man In The Middle” or even of “P-Fishing” cannot be prevented with this solution.

This fraud technique consists of usurping the identity of a user with the goal of obtaining a sufficient amount of information to pass oneself off for him at a service provider and to carry out operations to one's own advantage. The usurper has here a certificate to make the user believe that he is indeed on the site of the service provider, for example, a bank site, and that he has its own certificate.

Thus, a user, who will try to connect to the site of a service provider, will, in reality, be routed to another site.

The present invention prevents this type of fraud.

It pertains to a method of securing operations carried out in a network between a user and a service provider. This method is used by means of devices according to the present invention.

The method includes, for the user, a step of sending at least one identification datum from the user to the service provider and, for the service provider, a step of sending at least one authentication datum from the service provider to the user. Such identification and authentication data are designed to be used in a secure mode of operations, for example, of the SSL type.

In addition, the method includes, for the user, a step of generating a dynamic encryption key, a step of encrypting the received authentication datum by means of the said dynamic encryption key, and a step of sending the encrypted authentication datum to the service provider. The method additionally includes, for the service provider, a step of dynamic decryption of the encrypted authentication datum and a step of verification of the decrypted authentication datum in order to authorize the operation in secure mode.

The present invention makes it possible to have changing information, the dynamic encryption key, which is known to the user and to the true service provider and which is not known to the usurper. The dynamic nature of the encryption key makes it possible to prevent the person committing fraud from being able to easily discover this by any of the known pirating means. In fact, the unchanged encryption key over time might be pirated according to techniques similar to those observed with a bank card code, which is, itself, unchanged over time.

According to one embodiment of the present invention, the identification datum is also encrypted during the encryption step by means of the dynamic encryption key, sent with the encrypted authentication datum, and decrypted during the decryption step.

The encryption of the identification datum by means of the dynamic key enables the service provider to know with which user the connection is pirated. It also enables the user to be protected against a subsequent use of his identification datum or data, known to the usurper, in an unsecured method of identification, such as that proposed by the present invention. Such a situation is encountered, for example, when a partial migration is carried out between two types of identification methods and/or when a several types of identification methods exist at the same time.

In addition, such an encryption of the identification datum may enable the user not to communicate an identification datum that is not encrypted with the dynamic encryption key and therefore not to divulge an identification datum in an uncoded manner. Such a characteristic makes possible an even greater securing, especially vis-à-vis a principle of fraud, such as “Phishing.”

According to one embodiment of the present invention, the authentication datum is, for example, a certificate according to the SSL (Secured Socket Layer) protocol.

According to one embodiment, the method includes, for the user, a step of downloading means for carrying out the encryption step. Such means for carrying out the encryption step may be what is commonly called a “plug-in.” Of course, the means for carrying out the encryption step may also be integrated natively or by various techniques of installation in a device made available to the user.

According to one embodiment, the step of generating the dynamic encryption key is at least partly carried out by an off-line object.

According to one embodiment, the identification datum is a first audio signature provided by the off-line object.

Advantageously, the off-line object uses an audio variation method designed to vary a second audio signature from which the dynamic encryption key is generated, the decryption step also being used by means of the said audio variation method.

The present invention also pertains to a device designed to be made available to a user and including means for using the steps of the method carried out by the user.

According to one embodiment, means for generating the dynamic encryption key, which are associated with the device, are at least partly implemented on an off-line object in relation to the said device.

According to one embodiment, the off-line object is a card. Of course, the format of such a card may or may not be ISO.

According to one embodiment, the card is an audio card.

Advantageously, the audio card provides the identification datum in the form of a first audio signature.

The present invention also pertains to a device designed to be made available to a service provider and including means for carrying out the steps of the method carried out by the service provider.

According to one embodiment, at least a part of the dynamic decryption means are implemented in a server associated with the device of the service provider.

According to one embodiment, the dynamic decryption means use variation means to vary the dynamic decryption means upon each receipt of the identification datum.

Other characteristics and advantages of the present invention shall become evident with the description provided below, the latter being done in a descriptive and nonlimiting manner, making reference to the drawings below, in which:

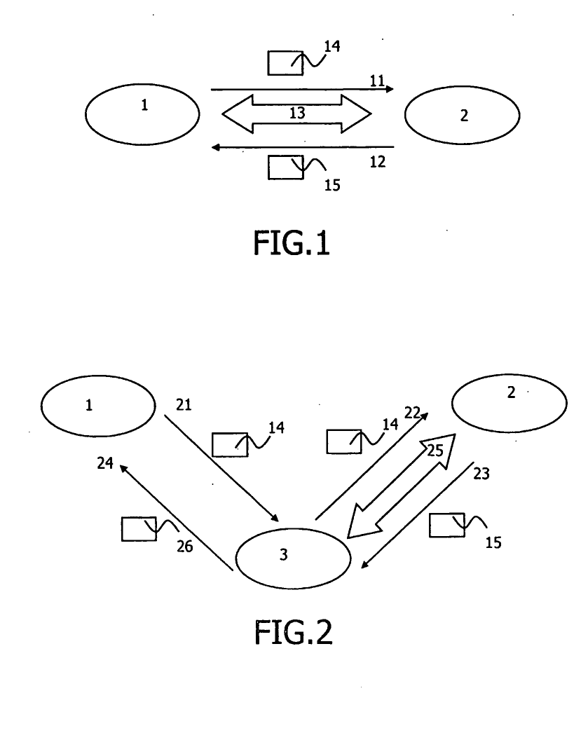

FIG. 1 shows an operation in secure mode as known in the state of the art;

FIG. 2 shows a pirated operation as encountered with the operations of the state of the art;

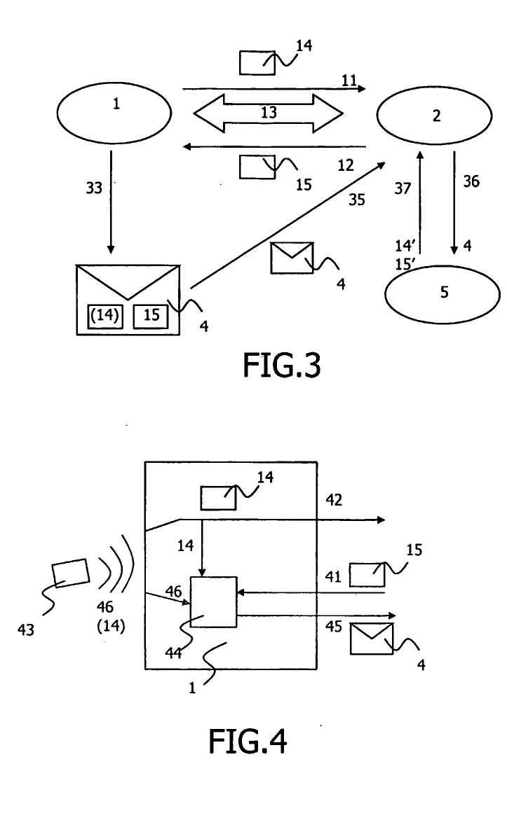

FIG. 3 shows an operation secured with a method according to the present invention, this operation using devices according to the present invention;

FIG. 4 is a diagram of a device according to the present invention designed to be made available to a user; and

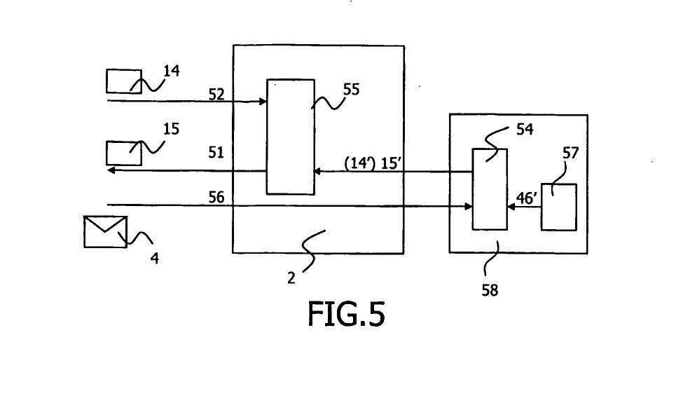

FIG. 5 is a diagram of a device according to the present invention designed to be made available to a service provider.

According to FIG. 1, an operation 13 in SSL secure mode is carried out by a user 1 and a service provider 2. According to the SSL protocol, during a first step 11, the user connects to the site of the service provider, for example, on the site of a bank service, and is authenticated by means of an identifier and a password, for example. Identification data 14 are therefore sent to the service provider 2. The user 1 also receives a certificate from the service provider in a step 12, which may be before or after his identification. Such a certificate constitutes an authentication datum 15. After analysis of the identification data of the user, the service provider 2 authorizes the establishment of an operation 13 in secure mode.

Depending on the use of networks, routing tables, for example, ARP (Address Resolution Protocol) tables, in which especially the cached, last sites visited and/or favorite sites are found, are used to store the addresses of sites (MAC addresses for Media Access Control, for example). Such tables especially help the user to connect to the sites of service providers.

According to FIG. 2, a “man in the middle” or “P-Fishing” or “Phishing” attack is a type of attack, in which an identity usurper 3 intervenes transparently in a connection between a user 1 and a service provider 2.

According to this type of attack, an identity usurper device 3 sends a request to know the addresses of target devices 1 and 2 with which it wishes to communicate. It then sends two data packets from falsified routing tables to the target devices: that of a user 1 and that of a service provider 2 in the case of FIG. 2. It then indicates to the target devices 1 and 2 that the address of the remote device (that of the device of the service provider for the device of the user and vice versa) has changed. The target device then updates its routing tables with the erroneous data which contain the address of the identity usurper device 3.

According to FIG. 2, a user 1 carries out a step of connection 21 to the site of a service provider. However, an identity usurper device 3, which is changing the routing tables, reroutes the connection to a site having all the characteristics of the site of the service provider. A true/false (because it is perfectly valid in the eyes of the user) certificate 26 is used as the authentication datum of the identity usurper device at the user 1.

During the connection, the packets are thus sent to the address of the identity usurper device 3. Then, each packet sent from one device to the other during the connection passes through the identity usurper device 3. The sending of falsified data packets, including routing tables, is carried out regularly in order to avoid a return to normal, where correct addresses are stored in the routing tables. In fact, a device connected to a network updates its routing tables very frequently: every 30 seconds or every 2 minutes, for example, this lapse of time being configurable on most operating systems.

At this level, the identity usurper device 3 receives all the packets exchanged between the two devices 1 and 2. However, this is not sufficient to pirate an operation in secure mode. It is also necessary for the identity usurper device 3 to resend the packets to the target devices 1 and 2 for the connection between the two target devices 1 and 2 to continue and for the identity usurper device to be able to “listen to” the connection, while remaining transparent in the connection.

The identity usurper device 3 then retrieves the identification data 14 of the user. In a step 22, the identity usurper device 3 then transfers these identification data 14 to the device of the service provider 2. According to the same mechanism of analysis explained above, the service provider 2 authorizes the identity usurper device 3 to access the services in an operation in secure mode 25 based on the presence of a certificate 15 provided to the identity usurper device in a step 23.

In a step 24, the identity usurper device 3 informs the user 1 about an error and asks him to reconnect later.

The identity usurper device 3 is, as far as it is concerned, identified and can carry out all sorts of operations in secure mode 25 in the place of the user 1 at the service provider 2.

Many sectors offering services on networks, especially on the Internet, are affected by such a pirating. This pirating is particularly annoying for payment services. Preventing such a pirating is all the more critical since the creation of a site appearing to be an authentic site is not difficult.

According to FIG. 3, a method according to the present invention is used in at least two devices made available to the user 1 and to the service provider 2, respectively.

According to this method, the user 1 is connected to the service provider 2 during a first step 11. An authentication certificate 15 from the service provider 2 himself is provided in a step 12, which may be before or after a step of sending identification data by the user 1 to the service provider.

According to the present invention, the device of the user comprises means 33 for generating a dynamic encryption key and for encrypting at least the authentication datum 15. It has been seen that the identification datum 14 was also advantageously encrypted by means of the dynamic encryption key. After encryption of the data, these encrypted data 4 are sent to the service provider. The encrypted data 4 are then inserted into a virtual envelope 4 which a potential identity usurper device would not be able to open. In fact, to open the envelope 4, i.e., to decrypt the encrypted data, the identity usurper device would have to have knowledge of the dynamic encryption key. With this key being dynamic, it varies over time. In addition, as it is not transmitted, it is therefore not accessible to any device placed between the device of the user 1 and that of the service provider 2.

The envelope 4 is then sent to the service provider 2 in a step 35. The device of the service provider 2 is associated with means for opening the envelope 4, i.e., for decrypting the encrypted data 4.

These means may especially, as shown in FIG. 3, be used in a server 5 communicating with the device of the service provider 2. In this case, the device of the service provider 2 sends the envelope 4 to the server 5 in a step 36 and the server returns the decrypted data 14′ to him and, if necessary 15′, in a step 37. The decryption may also be carried out in the device of the service provider 2 itself. According to the present invention, it is then verified that the user 1 has indeed received the good authentication datum 15 by comparing the decrypted authentication datum 15′ to the authentic datum 15. This verification may be carried out either within the server 5 or within the device of service provider 2. Once this verification has been carried out, the access to the services and/or the operation in secure mode 13 is authorized or not.

When the identification datum is also encrypted and sent, the decrypted identification datum 14′ of the user 1 makes it possible to determine the user over the connection from which the identity usurper device is inserted.

The method according to the present invention makes a very high security possible. In the configuration according to the present invention, it is not possible to have an identity usurper device in the middle of the connection. In fact, if an identity usurper device is inserted in the connection established between the device of the user and that of the service provider, it cannot decrypt the envelope and must send it to the service provider for fear of seeing its connection interrupted.

In fact, the identity usurper device does not have access to the data contained in the envelope 4. It no longer has means for modifying or creating a false envelope because the dynamic encryption key is not known to it and is not sent.

The dynamic encryption key is, in fact, managed, on the one hand, by the user and, on the other hand, by the service provider without transmission between the two. Therefore, it is only known by the user and the service provider or the server to which the latter is associated.

In addition, the method according to the present invention makes it possible to find the identity usurper device again. In fact, when the service provider receives the envelope, it can decrypt it and discover that the certificate is not identical to the one that it itself sent. The service provider, then knowing the false certificate, the IP address source of the Internet access provider with which the identity usurper has an access contract (such an access provider may then offer the identity of the identity usurper device) and the MAC address of the identity usurper device, may take legal action against the identity usurper.

According to one embodiment of the present invention, the means for creating the envelope, which include the means of encryption by means of the dynamic encryption key, are downloaded by the user, for example, from the site of the service provider, and/or sent by the service provider. This downloading (or this sending) is, for example, carried out during the first connection of the user or during each connection of the user on the site of the service provider. In this case in which it would be possible for the identity usurper device to also download the encryption means and be able, by return, to deduce the key, the size of the key is significant (for example, 128 bits) so that the time needed to decode the key is greater than that which the service provider is disposed to accept during an identification attempt of a user.

The means for creating the envelope 4 may advantageously be such that the envelope 4 includes, in addition to the authentication datum and possibly the identification datum, other data, such as the date of the connection, the time, session data of the user, a signature that is sent during the connection . . .

For reasons of clarity, the step of creating the envelope including the steps of generating the dynamic encryption key and the encryption step is represented by only one reference 33 in FIG. 3. These steps shall be dissociated with the corresponding means in the descriptions proposed for FIGS. 4 and 5.

According to FIG. 4, a device 1 designed to be made available to a user includes sending means 42 for sending at least one identification datum 14 from the user to the device of the service provider 2 and receiving means 41 for receiving at least one authentication datum 15 from the device of the service provider 2.

The device 1 is associated with means for generating a dynamic encryption key 46. In FIG. 4, which shows a particular embodiment of the present invention, the generation means are implemented on an off-line object represented by a card 43.

This card 43 is advantageously an audio card 43, which may provide two types of signature: a first, so-called “on-line” signature which will be sent in an operation and a second, so-called “off-line” signature which is not sent. The audio card 43 has means for varying these two types of signature, especially as a function of the number of uses, time or duration of use of the card.

The method of varying such signatures may therefore especially be based on the number of uses of the off-line object. Counters are implemented in the off-line object and in association with the decryption means. These counters advance at the same time, taking all triggerings of the object into account, including accidental triggerings. The number of times that the variation method is activated (for example, by pressing a button placed on the off-line object) can therefore be taken into account. Also, the number of uses can, for example, be established as being the number of times that the first signature is sent. The variation method may also be based on time. In this case, the off-line object and the decryption means calculate the variation in the same lapse of time, for example, 30 seconds.

According to the present invention, the first signature advantageously provides the identification datum 14. The second audio signature is advantageously used by the card 43 to generate the dynamic encryption key 46. This second signature may also be the dynamic encryption key 46 itself.

In addition, the device 1 includes encryption means 44 to encrypt at least the authentication datum 15 received, by means of the said dynamic encryption key 46, and sending means 45 for sending the encrypted authentication datum, represented by an envelope 4 in all the figures, to the device of the service provider 2. Such means may also encrypt the said identification datum and therefore include it in the virtual envelope 4.

According to FIG. 5, a device 2 designed to be made available to a service provider 2 includes receiving means 52 for receiving at least one identification datum 14 from the device of the user 1 and sending means 51 for sending at least one authentication means 15 from the service provider 2 to the device of the user 1.

The device 2 additionally includes receiving means 56 for receiving the said authentication datum 4, encrypted by means of a dynamic encryption key 46. If necessary, the device 2 also receives the encrypted identification datum. The device 2 is associated with dynamic decryption means 54 for decrypting the said encrypted authentication datum 4 and with means 55 for verifying the decrypted authentication datum 15′ in order to authorize the operation in secure mode.

The decryption and verification means may be implemented in an equivalent manner in the device of the service provider itself or on a server with which the device of the service provider is associated. Thus, according to FIG. 5, which shows a particular embodiment of the present invention, the dynamic decryption means are used by a server 58 that is remote from the device of the service provider but is connected to same. According to this same figure, the server includes variation means 57 intended to vary the dynamic decryption means 54. Such variation means 57 may be similar to those used in the means for generating the dynamic encryption key 46 and thus provide, at the same time that the dynamic encryption key 46 is generated, a corresponding decryption key 46′.

Software may therefore be used in both of the devices of the user and the service provider in order to enable the encryption means and the decryption means to be in phase. For example, such software may be such that they generate, at the same time and independently of a connection between the devices of the user and of the service provider, the dynamic encryption key 46 in the device of the user 1 and a dynamic decryption key 46′ in the device of the service provider 2. These keys are advantageously generated at specific moments, for example, with each sending/receipt of an identification datum 14.

The use of an audio card has many advantages. An audio signature can easily be modified. An audio signature is not generally resident in a precise but itinerant machine. In addition, an audio signature cannot easily be copied. In fact, on a computer, the most common device in which the present invention can advantageously be used, an audio microphone, which is the most widespread audio pick-up, can only be listened to by a software once. Therefore, it is not possible for a pirate program to be able to copy the audio signature.

The steps of a method according to the present invention run within the devices described in FIGS. 4 and 5. The functionalities used according to this method can be created by hardware or software means or by a combination of such means. When the use is created by software means, the present invention can utilize a computer program product including instructions so as to carry out the method according to the present invention.

1-23. (canceled)

24. Method of securing operations carried out in a network between a user (1) and a service provider (2), the method including, for the user (1), a step of sending (11) at least one identification datum (14) from the user (1) to the service provider (2) and, for the service provider (2), a step of sending (12) at least one authentication datum (15) from the service provider (2) to the user (1), the identification (14) and authentication (15) data being designed to be used in a secure mode of operation (13),
the method additionally includes, for the user (1), a step of generating (33) a dynamic encryption key, which is known only to the user and to the service provider and without transmission between the two, a step of encrypting (33) the received authentication datum (15) by means of the dynamic encryption key, and a step of sending (35), to the service provider (2), the encrypted authentication datum (15) in a virtual envelope (4), so that a potential identity usurper device will not be able to open it, nor to modify it, and will not be able to create a false envelope, and in that the method includes, for the service provider (2), a step of dynamic decryption (5) of the encrypted authentication datum and a step of verification (5) of the decrypted authentication datum in order to authorize the operation in secure mode (13).

25. Method in accordance with claim 24, in which the identification datum (14) is also encrypted during the encryption step by means of the dynamic encryption key, which is sent in the virtual envelope (4) with the encrypted authentication datum, and which is decrypted during the dynamic decryption step.

26. Method in accordance with claim 24, in which the virtual envelope (4) includes, in addition to the authentication datum and possibly the identification datum, other data, such as the connection date, the time, session data of the user, a signature that is sent during the connection.

27. Method in accordance with claim 24, including, for the user (1), a step of downloading means for carrying out the encryption step.

28. Method in accordance with claim 24, in which the step (33) for generating the dynamic encryption key is at least partly carried out by a off-line object (43).

29. Method in accordance with claim 28, in which the identification datum (14) is a first audio signature provided by the off-line object (43).

30. Method in accordance with claim 28, in which the off-line object (43) uses a audio variation method (57), which is designed to vary a second audio signature from which the dynamic encryption key (46) is generated, the decryption step (33) also being implemented by means of the audio variation method (57).

31. Method in accordance with claim 24, in which the authentication datum (15) is a certificate according to the SSL (Secured Socket Layer) protocol.

32. Device (1) designed to be made available to a user (1) for carrying out, within a network, operations secured by a device of a service provider (2), the device (1) provided to the user including sending means (42) for sending at least one identification datum (14) from the user (1) to the device of the service provider (2) and receiving means (41) for receiving at least one authentication datum (15) from the device of the service provider (2), the identification (14) and authentication (15) data being designed to be used in a operation in secure mode (13),
said device (1) being associated with means for generating (43) a dynamic encryption key (46), known only to the user and to the service provider and without transmission between the two, the device (1) including encryption means (44) for encrypting at least the received authentication datum (15) by means of the dynamic encryption key (46), means for creating a virtual envelope so that a potential usurper device will not be able to open it, modify it, or create a false envelope, and into which is inserted the authentication datum, and sending means (45) for sending the virtual envelope containing the encrypted authentication datum (15) to the device of the service provider (2).

33. Device in accordance with claim 32, in which the identification datum (14) is also encrypted by the encryption means by means of the dynamic encryption key and sent in the virtual envelope with the encrypted authentication datum.

34. Device in accordance with claim 32, in which the means for creating the envelope are such that the envelope includes, in addition to the authentication datum and possibly the identification datum, other data, such as the connection date, the time, session data of the user, a signature that is sent during the connection.

35. Device (1) in accordance with claim 32, including means for downloading the encryption means (44), especially from the device of the service provider (2).

36. Device (1) in accordance with claim 32, in which the means for generating (43) the dynamic encryption key (46), which are associated with the device, are at least partly implemented on a off-line object (43) in relation to the device (1).

37. Device (1) in accordance with claim 36, in which the off-line object (43) is a card.

38. Device (1) in accordance with claim 37, in which the card is an audio card.

39. Device (1) in accordance with claim 38, in which the audio card provides the identification datum (14) in the form of a first audio signature.

40. Device (1) in accordance with claim 39, with the audio card using audio variation means designed to vary a second audio signature, especially during the providing of the identification datum, the second audio signature being used by the generation means (43) to generate the dynamic encryption key (46).

41. Device (2) designed to be made available to a service provider (2) for carrying out, within a network, operations secured with a device of a user (1), the device (2) made available to the service provider (2) including receiving means (52) for receiving at least one identification datum (14) from the device of the user (1) and sending means (51) for sending at least one authentication datum (15) from the service provider (2) to the device of the user (1), the identification (14) and authentication (15) data being designed to be used in a operation in secure mode (13),
said device (2) additionally including receiving means (56) for receiving a virtual envelope (4) so that a potential identity usurper device will neither be able to open it, nor to modify it, and will not be able to create a false envelope, and in which is inserted the encrypted authentication datum by means of a dynamic encryption key (46), which is known only to the user and to the service provider and without transmission between the two, and being associated with dynamic decryption means (54) for decrypting the encrypted authentication datum (15) and with means for verifying (55) the decrypted authentication datum (15) in order to authorize the operation in secure mode (13).

42. Device in accordance with claim 41, in which the identification datum (14), which is encrypted by means of the dynamic encryption key, is also received in the virtual envelope (4) by the device and decrypted by the dynamic decryption means.

43. Device (2) in accordance with claim 41, in which the envelope includes, in addition to the authentication datum and possibly the identification datum, other data, such as the connection date, the time, session data of the user, a signature that is sent during the connection.

44. Device (2) in accordance with claim 38, in which at least a part of the dynamic decryption means (54) are implemented in a server (58) associated with the device of the service provider (2).

45. Device (2) in accordance with claim 41, in which the dynamic decryption means (54) use variation means (57) designed to vary the dynamic decryption means (54), especially upon each receipt of a identification datum (14).

46. Device in accordance with claim 32, in which the authentication datum (15) is a certificate according to the SSL (Secured Socket Layer) protocol.

47. Device in accordance with claim 41, in which the authentication datum (15) is a certificate according to the SSL (Secured Socket Layer) protocol.
